(19) United States
(12) Patent Application Publication
(10) Pub. No.: US 2020/0211132 A1
(43) Pub. Date: Jul. 2, 2020

(54) SYSTEM AND METHOD FOR GENERATING A PROBABILITY SCORE INDICATIVE OF A PROBABILITY THAT AN OWNER WILL SELL A REAL ESTATE PROPERTY

(71) Applicant: Skyline AI Ltd., Tel Aviv-Yafo (IL)

(72) Inventors: Or HILTCH, Rishon LeZion (IL); Guy ZIPORI, Kefar Saba (IL); Shay BUSHINSKY, Ganei Tikva (IL); Shmuel UR, D.N Misgav (IL)

(73) Assignee: Skyline AI Ltd., Tel Aviv-Yafo (IL)

(21) Appl. No.: 16/729,833

(22) Filed: Dec. 30, 2019

Related U.S. Application Data
(60) Provisional application No. 62/786,892, filed on Dec. 31, 2018.

(51) Int. Cl. G06Q 50/16; G06N 7/00; G06N 20/00

(52) U.S. Cl. CPC G06Q 50/16; G06N 20/00; G06N 7/005

(57) ABSTRACT

A system and method for computerized method for generating a probability score indicative of a probability that an owner will sell a real estate property, comprising: collecting from data sources a set of data associated with a plurality of owners and a plurality of commercial real estate properties (CREs) related thereto, based on a data item indicating a type of a desirable CRE; analyzing the collected set of data using a machine learning technique executed by a computer; determining, based on the analysis, a desirable CRE, and an owner associated with the desirable CRE; determining a probability that the owner will sell the desirable CRE with a certainty level above a predetermined threshold within a predefined time period; and generating, based on the analysis, a probability score that is indicative of the probability that the owner is likely to sell the desirable CRE within the predefined time period.

### CROSS-REFERENCE TO RELATED APPLICATIONS

This application claims the benefit of U.S. Provisional Application No. 62/786,892 filed on Dec. 31, 2018, the contents of which are hereby incorporated by reference.

### TECHNICAL FIELD

The present disclosure relates generally to real-estate assessment tools, and more specifically to a system and methods for predicting if a commercial real estate property (CRE) is likely to be put on the market for sale, or react favorably to an offer, within a predefined time period.

### BACKGROUND

Although technological advances have been introduced in most industrial areas to improve efficiency and productivity, the real-estate domain currently requires a massive use of manual labor to perform tedious and costly steps. Commercial real estate property (CRE) is property that is used solely for business purposes and is sold or leased out to provide a workspace rather than a living space. Ranging from a single gas station to a huge shopping center, commercial real estate includes retailers of all kinds, office space, hotels, strip malls, restaurants, convenience stores, and the like.

One of the biggest advantages of commercial real estate is attractive leasing rates. In areas where the amount of new construction is either limited by land or by law, commercial real estate can have significant returns and offer considerable monthly cash flow. Industrial buildings generally rent at a lower rate, though they also have lower overhead costs compared to a commercial property. Commercial real estate also provides benefits of longer lease contracts with tenants compared to residential real estate. This gives a commercial real estate holder a considerable amount of cash flow stability, so long as their building is occupied by long-term tenants.

Restrictive rules and regulations are a primary deterrent for those wanting to invest in commercial real estate. Taxes, as well as the mechanics of purchase and maintenance responsibilities for commercial properties are obscured in legal documents that shift according to state, county, industry, size, zoning and various other parameters. Many current investors of commercial real estate either have specialized knowledge or employ people who do. Thus, the bar for entry into such investments can be significant.

Another hurdle for CRE investment is the increased risk brought with tenant turnover. With residence properties, the facilities requirements of a given tenant are almost the same as any previous or future tenant. With a commercial property, however, each tenant may have very different needs that require costly renovation or refurbishing. The building owner must adapt the space to accommodate each tenant's specialized needs. A commercial property with low vacancy but high tenant turnover may still lose money due to the cost of renovations for incoming tenants.

The process of purchasing a CRE can require significant expense in research and time to determine not only which properties are a positive investment, but also properties are likely to be available for purchase for an investor or potential owner. Additionally, certain owners must operate within limited timeframes, e.g., purchase CRE at specific times depending on interest of investors and cash available.

The research to prepare such sales and predict when desirable properties are available currently require significant manual labor and therefore is both costly and requires significant time to complete, which may cause a potential CRE transaction to be lost. It would be therefore advantageous to provide a solution that overcomes the deficiencies of the prior art by automatically and efficiently performing the research and prediction processes.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating a probability score indicative of a probability that an owner will sell a real estate property, comprising: collecting from one or more data sources a set of data associated with a plurality of owners and a plurality of commercial real estate properties (CREs) related thereto, based on a data item that indicates a type of a desirable CRE; analyzing the collected set of data using a machine learning technique executed by a computer; determining, based on the analysis, at least one desirable CRE, and at least one owner of the plurality of owners associated with the at least one desirable CRE; determining a probability that the at least one owner will sell the at least one desirable CRE with a certainty level above a predetermined threshold within a predefined time period; and generating, based on the analysis, a probability score that is indicative of the probability that the at least one owner is likely to sell the at least one desirable CRE within the predefined time period.

Certain embodiments disclosed herein also include a non-transitory computer readable medium having stored thereon instructions for causing a processing circuitry to perform a process, the process comprising: collecting from one or more data sources a set of data associated with a plurality of owners and a plurality of commercial real estate properties (CREs) related thereto, based on a data item that indicates a type of a desirable CRE; analyzing the collected set of data using a machine learning technique executed by a computer; determining, based on the analysis, at least one desirable CRE, and at least one owner of the plurality of owners associated with the at least one desirable CRE; determining a probability that the at least one owner will sell the at least one desirable CRE with a certainty level above a predetermined threshold within a predefined time period; and generating, based on the analysis, a probability score that is indicative of the probability that the at least one owner is likely to sell the at least one desirable CRE within the predefined time period.

Certain embodiments disclosed herein also include a system for generating a probability score indicative of a probability that an owner will sell a real estate property, comprising: a processing circuitry; and a memory, the memory containing instructions that, when executed by the processing circuitry, configure the system to: collect from one or more data sources a set of data associated with a plurality of owners and a plurality of commercial real estate properties (CREs) related thereto, based on a data item that indicates a type of a desirable CRE; analyze the collected set of data using a machine learning technique executed by a computer; determine, based on the analysis, at least one desirable CRE, and at least one owner of the plurality of owners associated with the at least one desirable CRE; determine a probability that the at least one owner will sell the at least one desirable CRE with a certainty level above a predetermined threshold within a predefined time period; and generate, based on the analysis, a probability score that is indicative of the probability that the at least one owner is likely to sell the at least one desirable CRE within the predefined time period.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a system utilized to discuss the various embodiments.

FIG. 2 is a block diagram of a server for generating a probability score indicating the likelihood that a commercial real estate property (CRE) will be sold within a predefined time period according to an embodiment.

FIG. 3 is a flowchart describing a method for generating a probability score indicating the probability that an owner of a CRE is likely to sell the CRE within a predefined time period according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for identifying owners of CREs that are likely to sell at least part of their CRE portfolio, or alternatively identify owners that might be willing to sell if approached. The system also enables a determination of the owner's motivation for potentially selling the CRE, for example, due to a loan that needs to be paid off soon. By collecting data that is associated with the owners, the CREs of the owners, and the like, the disclosed system generates a probability score for each CRE. One key advantage for providing such probability score for a desirable CRE is the saving the cost of transactions, by doing due diligence to less CREs and reduce approaching cost. Therefore, it will be very desirable to automatically locate relevant prospects.

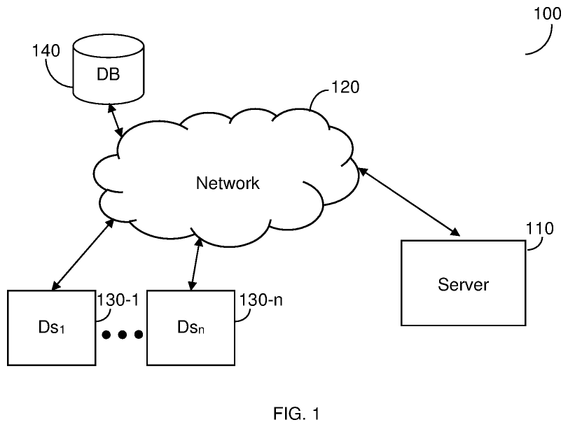

FIG. 1 is an example of a block diagram of a system 100 utilized to describe the disclosed embodiments. The system 100 includes a server 110 connected to a network 120. The network 120 is used to communicate between different parts of the system 100. The network 120 may be the Internet, the world-wide-web (WWW), a local area network (LAN), a wide area network (WAN), a metro area network (MAN), and other networks capable of enabling communication between the elements of the system 100.

Additionally, connected to the network 120 is a plurality of data sources 130-1 through 130-n, where n is an integer equal to or greater than 1 (hereinafter referred to as data source 130 or data sources 130 for simplicity), and a database 140. The data sources 130 may include public or private websites, such as real-estate comparison websites, similar web sources, and the like. The database 140 may be for example, a data warehouse, a cloud database, governmental databases, geo-location databases, demographic databases, and the like.

According to the disclosed embodiments, the server 110 is configured to analyze data to generate a probability score indicating the probability that an owner of commercial real estate properties (CRE) (hereinafter CRE or CREs for plural) is likely to sell one or more CREs that are not currently offered for sale within a predefined time period. Such properties may include commercial real-estate, multi-family houses, residential buildings, vacant lots, and the like.

In an embodiment, the server 110 is configured to receive a request to collect a set of data that is associated with a plurality of owners and of a plurality of CREs related to the owners. The request may include data items indicating a type of a desirable CRE. For example, the request may include data items indicating that the desirable CREs must be located in a certain city, must have an estimated value that is within a price range of 7-10 million dollar, and so on.

The set of data may include for example, a type of the owner, an identity of the owner, financial data of the owner, the owner's CRE portfolio, performances of the owner's CRE portfolio, CRE average holding duration, the owner's policy, the owner's recently completed transactions, the owner's public domain knowledge, and the like.

The type of the owner may indicate that the owner is a private entity, a fund, a public company, and so on. The identity of the owner may refer to the specific name, contact information, and the like, of the owner. Financial data of the owner may include, for example, loans that need to be paid off within a predefined time period, owner's cash flow, and so on. The owner's CREs portfolio may be related to the number of properties the owner holds, the value of each property and/or CRE, the number of transactions made over a predefined time period, and so on. The performances of the owner's CRE portfolio may include information regarding the most valuable CRE, the less valuable CRE, the average value of the CREs portfolio, and the like. The CRE average holding duration is the time the owner holds the CREs, e.g., a first owner holds the CREs for five years on an average, while a second owner holds the CREs for seven years on an average. The owner policy may indicate, for example, that the owner, e.g., a fund, is committed to hold CREs for up to five years. The owner's recently completed transactions may be indicative of CREs transactions as well as on other transactions that may indicate the owner financial status. Public domain knowledge about the owner may be indicative of the owner financial status, new directors, and the like. The owner's public domain knowledge may be retrieved from news, financial data of public companies, the Internet, social media, and so on.

In an embodiment, the set of data may further include environmental data such as information associated with transactions in real estate properties that are located in proximity to the CREs of the plurality of owners. In a further embodiment, the set of data may further include general financial data such as stock market trends. According to another embodiment, the set of data may also include information that is indicative of each CRE status, e.g., whether the CRE or a portion thereof was recently renovated, whether the rent has changed, and the like. The information that is indicative of each CRE status, when analyzed, may indicate the probability that the owner of the CRE will be willing to sell the CRE.

In an embodiment, the server 110 is configured to collect, based on the request, from the plurality of data sources 130 the set of data that is associated with the plurality of owners and the plurality of CREs related thereto. It should be noted that although the request indicates a desirable type of CREs, in an embodiment, the server 110 is configured to further search and collect additional data associated with the owners of the desirable CREs and other non-desirable CREs the owners may have.

In an embodiment, the server 110 is configured to analyze the collected set of data using a prediction model. In an embodiment, the analysis may be achieved by applying a predetermined set of rules to the collected set of data. The predetermined set of rules may state that, for example, if the owner, e.g., a fund, has a policy that states that CREs shall be held by the owner for up to five years, and the fund is currently holding three CREs for four and a half years, the probability that the owner would like to sell the four CREs is relatively high. In an embodiment, the analysis may be achieved by applying at least one machine learning technique to the collected set of data for determining which of the owners that holds at least one desirable CRE is likely to sell one or more of the CREs.

In a further embodiment, the machine learning technique may include one or more signal processing techniques, implementation of one or more neural networks, recurrent neural networks, decision tree learning, Bayesian networks, clustering, and the like, based on the collected set of data. It should be noted that different parameters represented by the set of data may be analyzed using different machine learning techniques.

In an embodiment, the server 110 is configured to determine, based on the analysis, at least one owner of the plurality of owners that is associated with at least one desirable CRE that is likely to sell the at least one desirable CRE in a certainty level that is above a predetermined threshold, within a predefined time period. The certainty level may be implemented as a numeral value that indicates the probability that an owner will be willing to sell one or more CREs. The certainty level may be determined based on historical data gathered with respect to the specific owner, one or more similar owners having similar characteristics, similar market conditions, and so on. The predefined time period may be for example, six months, two months, one year, and the like.

As a non-limiting example, the server 110 may determine that three owners are likely to sell at least part of their CREs portfolio in case a bid is made. According to the same example, the determination is achieved based on the results of the analysis, i.e., considering the fact that the three owners have loans that need to be paid within two months, that all three are dealing with cash flow problems, that similar owners having similar characteristics have been selling their CREs over the last six months, and so on.

In an embodiment, the server 110 is configured to generate, for at least one desirable CRE that is associated with the at least one owner, a probability score that is indicative of the probability that the at least one owner is likely to sell the at least one desirable CRE within the predefined time period. The probability score may be calculated based on the analysis of the set of data collected from a plurality of data sources as further discussed herein above. The generated probability score may include, for example, a numerical value between 1 to 5, where 1 is the lowest score indicating that the likelihood that the owner will be willing to sell the specific CRE within the predefined time period is very low, and 5 is highest score indicating that the likelihood that the owner will be willing to sell the specific CRE within the predefined time period is very high.

In a further embodiment, the server 110 may generate a relatively high probability score, indicating that the owner will be willing to sell a desirable CRE, e.g., based on data indicating that the desirable CRE is underperforming comparing to other CREs of that owner. As a non-limiting example, an owner has five CREs that are considered as desirable CREs, i.e., the CREs are within a desired price range, located in desirable locations, and so on. According to the same example, the first desirable CRE of the five desirable CREs has been underperforming compared to the other four desirable CREs. Therefore, the server 110 may determine that the owner of the five desirables CREs is more likely to sell the first desirable CRE compares to the other four desirable CREs, and therefore the probability score that is associated with the first desirable CRE will be relatively high.

According to the same example, in case the second desirable CRE provides better performances for the owner, it may be determined that the owner would not be likely to sell the second desirable CRE, and therefore the probability score, indicating the probability that the owner will choose to sell the second desirable CRE within the predefined time period, will be relatively low. It should be noted that in order to generate the probability score, the server 110 may collect and analyze data associated with desirable CREs of the owner and other CREs of the owner which are not considered as desirable CREs.

According to another embodiment, based on the generated probability score, the server 110 may be configured to automatically evaluate the price the owner will sell the CRE for without opening the CRE for bids. For example, the collected and analyzed data is utilized by the server 110 for determining that a CRE located at Denver, Colo., USA, has a high probability score indicating that the probability the CRE's owner is likely to sell the CRE is relatively high.

According to an embodiment, the server 110 may be configured to generate a list of desirable CREs determined to have a probability score that is above a predetermined threshold. The list of desirable CREs may include only CREs the owner is likely to try selling, above a certainty level, within a predefined time period and/or CREs the owner is willing to sell, above a certainty level, within a predefined time period.

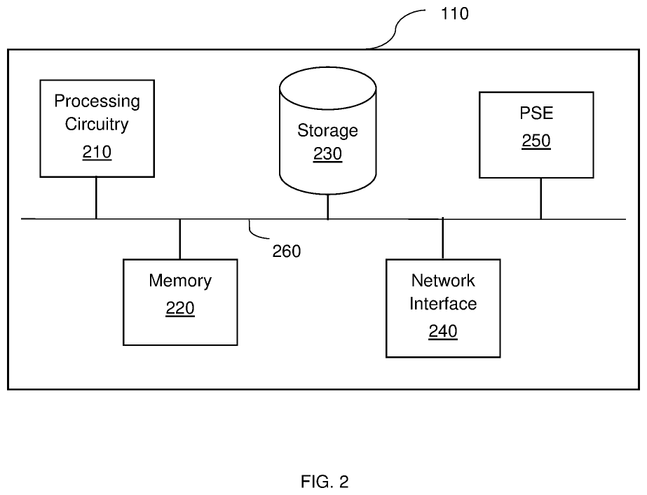

FIG. 2 is an example block diagram of the server 110 constructed according to an embodiment. The server 110 includes a processing circuity 210 coupled to a memory 220, a storage 230, a network interface 240, and a probability score engine (PSE) 250. In an embodiment, the components of the server 110 are connected by a communication bus 260.

The processing circuity 210 may be realized by one or more hardware logic components and circuits. For example, and without limitation, illustrative types of hardware logic components that can be used include: FPGAs, ASICs, ASSPs, SOCs, CPLDs, general-purpose microprocessors, microcontrollers, DSPs, and the like, or any other hardware logic components that can perform calculations or other manipulations of information. The memory 115 may be volatile (e.g., RAM,), non-volatile (e.g., ROM, flash memory, and the like), or a combination thereof.

The storage 130 may be magnetic storage, optical storage, solid state storage, and the like and may be realized, for example, as flash memory or other memory technology, CD-ROM, DVDs or other optical storage, magnetic cassettes, magnetic tape, magnetic disk storage or other magnetic storage devices, or any other medium which can be used to store the desired information.

In one configuration, computer readable instructions to implement one or more embodiments disclosed herein may be stored in the storage 230. The storage 230 may also store other computer readable instructions to implement an operating system, an application program, and the like. Computer readable instructions may be loaded in the memory 220 for execution by the processing circuity 210.

In another embodiment, the storage 230, the memory 220, or both, are configured to store software. Software shall be construed broadly to mean any type of instructions, whether referred to as software, firmware, middleware, microcode, or hardware description language. Instructions may include code (e.g., in source code format, binary code format, executable code format, or any other suitable format of code). The instructions cause the processing circuity 210 to perform the various functions described herein.

The network interface 240 allows the server 110 to communicate with external sources. For example, the network interface 240 may be configured to access or communicate with a network or various data sources.

In an embodiment, the network interface 240 allows remote access to the server 110 for the purpose of, for example, configuration, reporting, and the like. The network interface 240 may include a wired connection or a wireless connection. The network interface 240 may transmit communication media, receive communication media, or both. For example, the network interface 240 may include a modem, a network interface card (NIC), an integrated network interface, a radio frequency transmitter/receiver, an infrared port, a USB connection, and the like.

The PSE 250 is configured to determine and generate a probability score indicating the likelihood that an owner of one or more CREs will be willing to sell one or more of the CREs, using a machine learning decision model. In an embodiment, the PSE 250 can be realized by one or more hardware logic components and circuits. For example, and without limitation, illustrative types of hardware logic components that can be used include: FPGAs, ASICs, ASSPs, SOCs, CPLDs, general-purpose microprocessors, DSPs, and the like, or any other hardware logic components that can perform calculations or other manipulations of information.

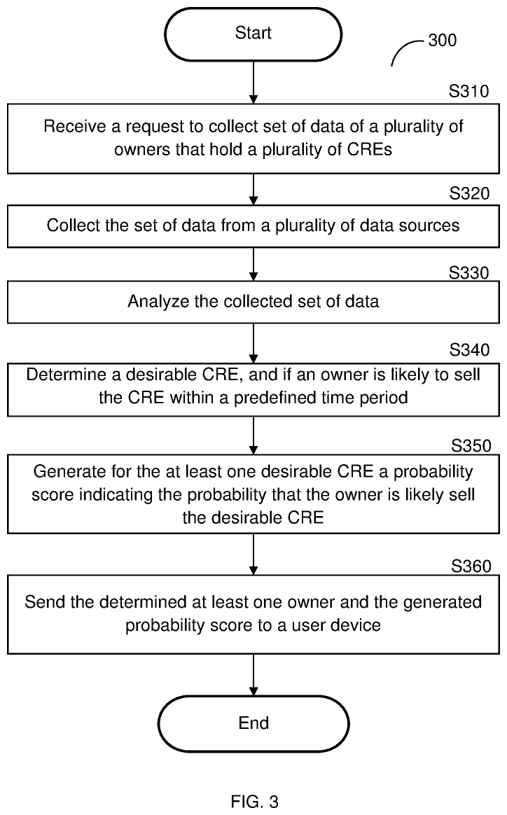

FIG. 3 is an example flowchart 300 describing a method for generating a probability score for a probability that an owner of a commercial real estate (CRE) is likely to sell the CRE property within a predefined time period according to an embodiment.

At S310, a request to collect a set of data that is associated with a plurality of owners and of a plurality of CREs related thereto, is received. The request includes at least a data item indicating a type of a desirable CRE.

At S320, the set of data is collected from a plurality of data sources. The set of data may include, for example and without limitation, a type of the owner, an identity of the owner, financial data of the owner, owner's CRE portfolio, performances of the owner's CRE portfolio, average holding duration, owner financial policy, owner's recent completed transactions, owner's public domain knowledge.

The plurality of data sources may include public or private websites, such as real-estate comparison websites, and the like.

At S330, the collected set of data is analyzed. The analysis may be achieved using one or more machine learning technique. In an embodiment, the machine learning technique may include one or more signal processing techniques, implementation of one or more neural networks, recurrent neural networks, decision tree learning, Bayesian networks, clustering, and the like. It should be noted that different parameters represented by the set of data may be analyzed using different machine learning techniques. In a further embodiment, the analysis may be achieved by applying a set of rules to the collected set of data.

At S340, at least one desirable CRE is determined, along with an owner associated with the at least one desirable CRE, and whether they are likely to sell one or more of the desirable CREs within a predefined time period. That is, while multiple owners may be identified as owners of desirable CREs, only the owners that are determined to be willing to sell one or more of their CREs are searched for.

At S350, a probability score that is indicative of the probability that the owner of the one or more desirable CREs is likely to sell at least one desirable CRE, within the predefined time period, is generated for at least one of the CREs of the owner.

At optional S360, the generated probability score and the determined at least one owner are sent to a user device, e.g., the computer from which the initial request had been received from.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computerized method for generating a probability score indicative of a probability that an owner will sell a real estate property, comprising:
collecting from one or more data sources a set of data associated with a plurality of owners and a plurality of commercial real estate properties (CREs) related thereto, based on a data item that indicates a type of a desirable CRE;
analyzing the collected set of data using a machine learning technique executed by a computer;
determining, based on the analysis, at least one desirable CRE, and at least one owner of the plurality of owners associated with the at least one desirable CRE;
determining a probability that the at least one owner will sell the at least one desirable CRE with a certainty level above a predetermined threshold within a predefined time period; and
generating, based on the analysis, a probability score that is indicative of the probability that the at least one owner is likely to sell the at least one desirable CRE within the predefined time period.

2. The computerized method of claim 1, wherein the set of data comprises at least one of: a type of the at least one owner, an identity of the at least one owner, financial data of the at least one owner, the at least one owner's CRE portfolio, performances of the at least one owner's CRE portfolio, average holding duration of the at least one owner, the at least one owner's financial policy, the at least one owner's recently completed transactions, and the at least one owner's public domain knowledge.

3. The computerized method of claim 1, wherein the one or more data sources include at least one of: a public website, a private website, and a real-estate comparison website.

4. The computerized method of claim 1, wherein the machine learning technique is realized by any one of: a neural network, a recurrent neural network, a decision tree learning, a Bayesian network, and clustering.

5. The computerized method of claim 1, wherein analyzing the collected set of data further comprises:
applying a predetermined set of rules to the collected set of data.

6. The computerized method of claim 1, wherein analyzing the collected set of data further comprises: collecting additional data associated with the determined at least one owner of the at least one desirable CRE.

7. The computerized method of claim 6, wherein the additional data includes data associated with non-desirable CREs owned by the at least one owner.

8. The computerized method of claim 1, further comprising:
determining the certainty level to be above a predetermined threshold based on historical data gathered with respect to the at least one owner.

9. The computerized method of claim 1, further comprising:
determining the certainty level to be based on historical data gathered with respect to owners having similar characteristics to the at least one owner.

10. A non-transitory computer readable medium having stored thereon instructions for causing a processing circuitry to perform a process, the process comprising:
collecting from one or more data sources a set of data associated with a plurality of owners and a plurality of commercial real estate properties (CREs) related thereto, based on a data item that indicates a type of a desirable CRE;
analyzing the collected set of data using a machine learning technique executed by a computer;
determining, based on the analysis, at least one desirable CRE, and at least one owner of the plurality of owners associated with the at least one desirable CRE;
determining a probability that the at least one owner will sell the at least one desirable CRE with a certainty level above a predetermined threshold within a predefined time period; and
generating, based on the analysis, a probability score that is indicative of the probability that the at least one owner is likely to sell the at least one desirable CRE within the predefined time period.

11. A system for generating a probability score indicative of a probability that an owner will sell a real estate property, comprising:
a processing circuitry; and
a memory, the memory containing instructions that, when executed by the processing circuitry, configure the system to:
collect from one or more data sources a set of data associated with a plurality of owners and a plurality of commercial real estate properties (CREs) related thereto, based on a data item that indicates a type of a desirable CRE;
analyze the collected set of data using a machine learning technique executed by a computer;
determine, based on the analysis, at least one desirable CRE, and at least one owner of the plurality of owners associated with the at least one desirable CRE;
determine a probability that the at least one owner will sell the at least one desirable CRE with a certainty level above a predetermined threshold within a predefined time period; and
generate, based on the analysis, a probability score that is indicative of the probability that the at least one owner is likely to sell the at least one desirable CRE within the predefined time period.

12. The system of claim 11, wherein the set of data comprises at least one of: a type of the at least one owner, an identity of the at least one owner, financial data of the at least one owner, the at least one owner's CRE portfolio, performances of the at least one owner's CRE portfolio, average holding duration of the at least one owner, the at least one owner's financial policy, the at least one owner's recently completed transactions, and the at least one owner's public domain knowledge.

13. The system of claim 11, wherein the one or more data sources include at least one of: a public website, a private website, and a real-estate comparison website.

14. The system of claim 1, wherein the machine learning technique is realized by any one of: a neural network, a recurrent neural network, a decision tree learning, a Bayesian network, and clustering.

15. The system of claim 11, wherein the system is further configured to:
apply a predetermined set of rules to the collected set of data.

16. The system of claim 11, wherein the system is further configured to:
collect additional data associated with the determined at least one owner of the at least one desirable CRE.

17. The system of claim 16, wherein the additional data includes data associated with non-desirable CREs owned by the at least one owner.

18. The system of claim 11, wherein the system is further configured to:
determine the certainty level to be above a predetermined threshold based on historical data gathered with respect to the at least one owner.

19. The system of claim 11, wherein the system is further configured to:
determine the certainty level to be based on historical data gathered with respect to owners having similar characteristics to the at least one owner.
